(19) United States
(12) Patent Application Publication
(10) Pub. No.: US 2015/0067036 A1
(43) Pub. Date: Mar. 5, 2015

(54) System, Method And Apparatus For A Personal Server For Managing Personal Data and Personal Automation Tasks

(71) Applicants: Pradeep Nambiar, Austin, TX (US); Zahin Nambiar, Austin, TX (US)

(72) Inventors: Pradeep Nambiar, Austin, TX (US); Zahin Nambiar, Austin, TX (US)

(21) Appl. No.: 14/469,622

(22) Filed: Aug. 27, 2014

Related U.S. Application Data
(60) Provisional application No. 61/872,762, filed on Sep. 2, 2013.

(51) Int. Cl. H04L 29/06

(52) U.S. Cl. CPC H04L 67/42; H04L 69/16
USPC 709/203

(57) ABSTRACT

A system for managing personal data and personal automation tasks; comprising of one or more client computer, wide area network, one or more personal server computer, network router, local area network, external IP address, internal IP address, client applications, personal server applications, personal server controller application, personal server client applications, personal server operating system, client computer operating system and domain name service system components. The main system component, the personal server is designed to run around the clock is placed in the home or office premises of the personal server owner that facilitates managing personal data and personal automation tasks for the personal server owner with complete data privacy and data ownership; securely accessible from inside owner's premises via local area network or from outside the owner's premise via wide area network (internet).

### CROSS REFERENCE TO RELATED APPLICATION

This application is based on provisional application Ser. No. 61/872,762, filed on Sep. 2, 2013.

### STATEMENT REGARDING FEDERALLY SPONSORED RESEARCH OR DEVELOPMENT

Not Applicable

### DESCRIPTION OF ATTACHED APPENDIX

Not Applicable

### FIELD OF INVENTION

The present invention generally relates to the field of personal computing server system and more specifically to a system, method and apparatus for a personal server for managing, accessing, sharing and serving personal data and enabling personal automation tasks with complete control of personal data and data privacy.

### BACKGROUND OF THE INVENTION

Personal Computing became popular in the 1980s with the advent of Personal Computers (PCs). During the 1980's, people used PCs for a number of things such as gaming, document creation, word processing, printing document and storing personal data. The personal data remained on the Personal Computer and was backed up using floppies or other external storage medium. PCs were not connected and data privacy was not an issue.

With the advent of networking; PCs became connected with other PCs and limited data sharing started between PCs. External networks were created through gateway computers that let PCs talk to other PCs outside a local area network. All data sharing was between systems and usually between trusted parties. Once the data was transferred to other PCs via network, the users slowly lost control of their data. Data on other PCs and systems started to be defined by a different set of terms that are beyond the control of the original user that owned the data.

1990's saw the advent of Internet and Web technologies where PCs started to talk to computer systems from far flung locations. Web technologies introduced software applications that could reside on remote servers and could be accessible to number of users simultaneously. More and more people started to use the PC to connect to the Internet and Web Applications and people started to lose further control of their personal data as their personal data was stored on remote servers. Once the data leaves the PC, the data is managed by the owner of remote servers and policies of the application service providers. PCs soon started to become just a device to access and manage personal data stored on remote servers.

2000's introduced free web based electronic mail services offered by number of companies that lured many to share their personal electronic mail exchanges with companies that would scan mail messages to serve advertisements. Securing privacy and confidentiality to personal data became challenging. Surveillance of personal data exchanged through third party remote servers is raising concern on the privacy and confidentiality of personal data.

Today Personal Computing focuses on personal computer desktops and laptops that requires interaction and are being only used to access data or share data through a remote server owned by a separate entity or an application service provider. Applications are owned and managed by third parties. Currently users have a number of personal applications to manage personal data, but this data sits on remote servers where the user doesn't have direct control of their data. Data privacy is also not guaranteed as number of other entities may have access to the personal data through data sharing terms that the users may not even be aware of. The remote server also hosts data for millions or billions of users. A single security breach makes the personal data of all the users vulnerable. Decentralizing the personal data from remote servers into personal servers housed in one's own personal residence or office location will reduce the risk of such vulnerability to personal data. Users can have complete control of their data and can share or use the data on their own terms.

Technologies for personal data management and personal data sharing, electronic mail and secure exchange of data exists through various inventions. These technologies are used by service providers who offer services via the medium of Internet and Web technologies to a number of users with limited data privacy and confidentiality. Prior art on computer servers and computing devices that access remote data exists but does not address the basic needs of a managing personal data with complete control of personal data including using the same computing server to provide local encrypted backups to an external attached storage device that remains in possession with the data owner at all times, exchanging secured content without third party servers, scheduling and managing automated tasks, monitoring connected devices or data feeds from external systems and managing personal data associated with such devices and many such instances where personal data privacy requires the use of a dedicated personal server does not currently exists. Other key functions afforded by this invention are the use of the Personal Server as a personal mail server to send and receive of all electronic mails to a personal domain owned by the Personal Server owner. Secure message delivery of secure content directly from the Personal Server is also facilitated via the use of the Personal Server using HTTPS protocol.

This invention provides system, methods and a typical apparatus to enable such technologies such as mail services, voice services, streaming services, secure data exchange services for a single user or a very limited set of users trusted by the Personal Server owner through personally owned computing system called Personal Server that resides in the user's residential premises or office premises with complete control over the server and its data. The Personal Server can be accessed from within home through local area network or away from home via wide area network (Internet) using a domain name specifically assigned to the Personal Server owner or directly addressable IP (Internet Protocol) address that is known to the Personal Server owner. Using certain functions of the Personal Server described in this invention may require a personal Internet Domain Name; the Personal Server owner can access some applications using an IP address instead of a domain name. Personal Server can be used to store, share data, act as an electronic mail server, secure exchange portal, and other software applications that are currently possible via third party servers. Owning the Personal Server extends the same capabilities that shrink wrapped software provides to a Personal Computer, but for a Personal Server that can be installed on the Personal Server to be used by the Personal Server owner or limited set of users the Personal Server owner authorizes. As the Personal Server is designed for continuous operation, it also monitors externally directly connected devices or networked devices with the Personal Server owner's residential premises or office location and notifies the Personal Server owner whenever pre-defined conditions are met to drive scheduled automated tasks. Scheduled automation tasks can be created in complete privacy and without the need for a third party server. Automation task completion can be notified by e-mail or other communication methods to the Personal Server owner or additional external subscribed services the Personal Server owner may choose to purchase.

### BRIEF SUMMARY OF THE INVENTION

The primary object of the invention is to provide a System, Method and Apparatus for a Personal Server that is owned by the Personal Server Owner and placed in the owner's residence or office for managing personal data and personal automation tasks.

Another object of the invention is to provide a System, Method And Apparatus for a Personal Server that is controlled using a client computer device such as a smart phone, tablet, laptop or a desktop computer and operates continuously to store, serve and manage the personal data, personal applications, personal communications such as electronic mail, voice mail, electronic notifications and reminders for the Personal Server owner and users authorized by the Personal Server owner. Today such services require the use of third party servers where the data management policies are beyond the control of the users.

Another object of the invention is to provide a System, Method And Apparatus for a Personal Server that provides a repository for personal data that can be securely accessed by the Personal Server owner and users authorized by the Personal Server owner from within the home or office environment using Local Area Network or via the Wide Area Network (Internet) when the Personal Server owner and authorized users are away from home or office location.

A further object of the invention is to provide a System, Method and Apparatus for a Personal Server that provides complete control of the Personal Server, personal data and personal server communications and is housed securely at the Personal Server owner's home or office premises. Having a Personal Server and owning the personal data provides complete privacy and complete control of personal data that may include but not limited to electronic mail, graphical images, videos, documents, audio etc.

Yet another object of the invention is to provide a System, Method and Apparatus for a Personal Server that includes a modular software application controller that securely manages the Personal Server and installed Personal Server applications using a client computer and enables installation and configuration of new Personal Server applications for managing Personal Server owner's data and automation tasks.

Another object of the invention is to provide around the clock monitoring and notification that can notify and take authorized automated actions for the Personal Server Owner to react with changes related with for example home appliances, home control systems, external network connected monitoring devices or to serve personal data requests from authorized external applications or authorized users with complete privacy and control.

Another object of the invention is to provide a system that can network with authorized peer Personal Servers to form a trusted Personal Server Network to share personal data authorized by the Personal Server owner automatically.

Another object of the invention is to provide a personal electronic mail server that can send and receive mails for the Personal Server owner and also provide multiple ways to access mail without subscribing to third party mail servers.

Another object of the invention is to provide a secure backup and restore of personal data to an external attached storage device that can be securely kept by the Personal Server owner at his premises with complete control and knowledge about the personal data.

Other objects and advantages of the present invention will become apparent from the following descriptions, taken in connection with the accompanying drawings, wherein, by way of illustration and example, an embodiment of the present invention is disclosed.

The invention generally relates to a system, method and apparatus for personal server computing appliance for managing personal data and personal automation tasks which includes the following main or sum-elements: One or more Personal Servers (5.10), Wide Area Network (Internet) (5.20), Client Computer (5.30), Network Router (5.40), Local Area Network (5.50), External IP Address (5.60), Internal IP Address (5.70), Client Applications (5.80), Personal Server Applications (5.90), Personal Server Controller Application (5.100), Personal Server Client Application (5.110), Personal Server Operating System (5.120), Client Computer Operating System (5.130), Domain Name Service (5.140).

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

NOTE: This application use Figure references in two formats. Figure references that use the (N.MMM) format follows the convention where ‘N’ denotes the Figure number to easily locate a referencing item in a Figure. ‘MMM’ number the item in the referenced Figure. For example—Personal Server (1.110) refers to the Personal Server element marked 1.110 in FIG. 1.

FIG. 1: FIG. 1 is an upper perspective view of the present invention. FIG. 1 depicts the overview of this invention. This invention introduces the novel concept and utility of a Personal Server (1.110). A Personal Server concept is a new kind of personal computing appliance that is different from a desktop personal computer in a number of ways such as—a Personal Server does not need a computer display monitor and input devices for its normal operation. Personal Server is to serve the personal server owner or a very limited set of users authorized by the Personal Server owner. It is also designed to run continuously around the clock as an always on personal computing server. It may avoid or minimize components that include mechanical moving parts for example using a passive cooling technology instead of traditional cooling fans, a solid state device storage technology instead of traditional hard disks that require mechanical moving parts to read and write data. A Personal Server is housed in the Personal Server Owner's (1.160) home or office location where the Personal Server owner has complete control of the software, data and hardware unlike a remote server owned by third party companies and housed outside the user's residence at a remote data center location. A Personal Server is connected to the local area network (1.130) and can be accessed by client computing devices such as a laptop computer, tablet computer, personal desktop computer or a smart phone (1.140) using standard TCP/IP network protocols such as HTTP, HTTPS, FTP, SSH, X11 etc. The Personal Server can also be accessed by a standard internet browser or client computer native user interface that may be proprietary to the client device operating system. The Personal Server can be accessed from outside the Personal Server owner's (1.170) home or office location by exposing certain ports to the wide area network through the Personal Server owner's home or office network router (1.120). Assigning a hostname and domain name to the externally addressable Internet Protocol address (IP Address) assigned to the Personal Server owner's home or office network Internet modem (1.180) will enable addressing the Personal Server from the Wide Area Network (Internet) (1.150). An external hostname and domain name will require registering the name into a Domain Name Service (1.190). Network Routers (1.120) or the Personal Server have the ability to update the external IP address with the Domain Name Service automatically if the external IP address changes. This enables the Personal Server owner to access the Personal Server and associated personal data and applications from anywhere and anytime from the Wide Area Network (Internet) when the Personal Server Owner is outside the home or office location (1.160). Additional security measures can be placed to ensure the access is secure and confidential thereby protecting the Personal Server and its data.

FIG. 2: FIG. 2 is a block diagram illustrating sub-components of the element client computer device of the system of the present invention. FIG. 2 depicts a block diagram of a client computer device (1.140) that can be used for accessing the Personal Server (1.110). A client computer device could be a smart phone, tablet, laptop computer, a personal desktop computer or similar device (1.140) that have access to the home or office local area network (1.130) connected to the Personal Server (1.110) or that has access to the Personal Server through the wide area network (Internet) (1.150) when accessing the Personal Server (1.110) from outside the home or office location. Personal Server Owner's client computer device (1.140) include components such as a memory (2.230), a processor (2.220), a bus (2.210) which connects the various components of the device, an Input/Output (I/O) controller (2.240) that control the input and output including display, touch based input or a keyboard and pointing device (2.270). The client computer device also includes a network interface (2.260) that can connect to the network where the Personal Server (1.110) is connected. The client computer device may also include Global Positioning System (GPS) (2.280) component that can get the location of the client computer device owned by the Personal Server owner or it may have other means to determine the location of the client computer device based on Internet Protocol address of the current connection to the internet or other software means of finding the location of the client computer device. The client computer device may include custom client software applications written to specifically connect to a Personal Server to control the Personal Server or application services served by the Personal Server used by the Personal Server owner. Client computer device may also use web application that can use standard Internet protocols such as HTTP, HTTPS, FTP, SSH, X11 or similar to connect and access Personal Server applications installed on the Personal Server.

FIG. 3: FIG. 3 is a block diagram illustrating a sub-component of the present invention. FIG. 3 depicts a block diagram of the components of the main element of this invention the Personal Server (1.110). A Personal Server is a mini computer that is designed to run continuously. It is connected to the home or office local area network using a network interface. What differentiates a Personal Server from a Personal Computer is that for normal operation it need not have a display device or other input devices such as keyboard or mouse attached to it. While the Personal Server may have input and output ports for such devices, it is not necessary to connect these devices for its normal operation. The Personal Server (1.110) is accessed via network from a Personal Server Owner's client computer device such as a smart phone, tablet computer, laptop computer or desktop computer using standard network protocols. The client computer device can use a wired connection or a wireless connection to the network. The Personal Server (1.110) include a processor (3.320), memory (3.330), an input/output (I/O) controller (3.340), a mass storage device (3.350) for storing program code instructions for the operating system, applications and system and personal data (3.350), a networking interface (3.360), a bus (3.310) that connects the various components and facilitates data transfer and control.

FIG. 4: FIG. 4 is an upper perspective view of the present invention. FIG. 4 shows one possible structural design for Personal Server apparatus form factor. The Personal Server form factor is important in the practical use of the Personal Server computing appliance. The Personal Server apparatus is designed to be placed horizontally or vertically to save space. When placing vertically; an adjustable stand (4.440) adds stability to the apparatus. It is designed to run continuously and hence low power requirement needs to be considered in the selection of the CPU processor. A Personal Server is designed to be housed at home or office environment hence a low or no noise from the apparatus is another consideration. To eliminate noise the Personal Server is designed to avoid the use of mechanically moving parts where possible for example traditional fans to cool the apparatus can be replaced with a passive cooling technology such as metal fins placed over the top of the critical components that produce heat as shown in (4.430) can help dissipate heat quickly and therefore keep the Personal Server cool and within normal operating temperature. A typical design on the front panel will have a power switch and reset buttons (4.410) and optionally a small flat panel display or LCD (Liquid Crystal Display) that may have touch input to display status and control basic operation of the apparatus. The Personal Server front area may also include other forms display components such as LED (Light Emitting Diode) indicators. The Personal Server also has input connections for a one or more network interface (4.460), one or more Input/Output devices through Universal Serial Bus (USB) (4.470) or other similar interfaces and a display monitor (4.450) port. The Personal Server may not use the display monitor (4.450) for normal operation. A display monitor and input keyboard device is only used for trouble shooting or repair operations. The Personal Server also has a connection to connect the DC Power input via a power adapter placed outside the Personal Server.

FIG. 5: FIG. 5 is a block diagram illustrating the all the main components and sub-elements of the key system component of the system of the present invention. Personal Server (5.10) consists of hardware components—Processor (5.11), Memory (5.12), Bus (5.13), I/O Controller (5.17), Storage (5.15), I/O Ports (5.16), and Network Interface (5.14). Personal Server runs an operating system (5.120) that loads and manages Personal Server Applications (5.90). Personal Server (5.10) is connected to the Local Area Network (5.50) that is managed by a network router (5.40). The Personal Server is accessed using a client computer (5.30) over the network. The Personal Server can be reached using an internal IP address (5.70) within the local area network (5.50). The Personal Server can also be accessed from wide area network (Internet) (5.20) when the Personal Server Owner is outside the local area network using the external IP address (5.60) that is assigned to the Internet Modem (5.60) or a hostname and domain name associated with the external IP Address (5.60). The hostname and domain name is resolved to the external IP address via a Domain Name Service (5.140). The hostname and domain name is associated with the external IP Address (5.60) assigned to the Internet Modem (5.60) by the Internet Service Provider for the home or office location. The registration of the host name and domain name is managed via the Domain Name Service (5.140). If the external IP address is dynamic, the network router (5.40) updates the domain name service with the new external IP address, so that the hostname and domain name is synchronized with the latest external IP Address at all times. The Domain Name Service (5.140) keeps the hostname and domain name for the external IP Address associated with the Personal Server (5.10) refreshed in the Wide Area Network (Internet). The Personal Server Owner may be required to subscribe to the Domain Name Service to have the host name and domain name resolvable to the external IP Address or may choose to install a Domain Name Service on the Personal Server or another server. It should be noted the Domain Name Service is an optional component as the Client Computer may have other means of translating a hostname to the external IP address for example storing the translation locally on the Client Computer (5.30). The client computer (5.30) is used to access the Personal Server (5.10). The client computer (5.30) consists of the following sub elements—A processor (5.31), memory (5.33), bus (5.32) that is used to inter-connect the various sub-elements of the client computer, Input Output Controller (5.38), Mass Storage (5.35), display and input devices (5.37), and optionally a global positioning system (GPS) component (5.36) that can retrieve the geo location of the client computer device which can be used by the Personal Server controller application or Personal Server applications to take decisions based on the current location of the Personal Server owner. The client computer device runs an operating system (5.130) that manages the client computer and client applications (5.90) used to access the Personal Server. To access the Personal Server (5.10), the Client Computer (5.30) may include one or more Personal Server Client Applications (5.110) that facilitates Personal Server configuration and configuration of Personal Server applications and personal data access.

FIG. 6: FIG. 6 is a flowchart illustrating one of the methods of the present invention. FIG. 6 shows the block diagram of the inter connection of software components for a software application called Personal Server Controller Application (6.620). This application runs on the Personal Server (6.610) and provides functions to manage the Personal Server and Personal Server applications by the Personal Server Owner. Personal Server Controller Application (6.620) is responsible for configuring and setting up the configuration settings for the Personal Server Owner. This software application component may reside entirely on the Personal Server and listen to predefined network port to respond to commands to manage the Personal server. It may optionally have a client component that is installed on the client computer. The Personal Server Controller Application also acts like a portal application which the Personal Server owner uses to track the Personal Server configurations for the Personal Server Applications (6.630) and Personal Server data (6.640). The Personal Server Controller Application (6.620) can be accessed using any internet web browser running on the client computer devices (6.670) or using a native client application (6.680) that uses native software libraries of the client computer device. The Personal Server Controller Application can be secured using asymmetric key encryption by setting up a client and personal server key certificates and downloading the client certificate and key to the client computer device during the initial setup. Additional user id and password authentication may also be used to ensure a secure and confidential access to the Personal Server Controller Application. The Personal Server Controller Application (6.620) also helps configure Trusted Personal Server Network configuration and multiple Personal Server configurations as it relates with the alternate embodiment of this invention shown in FIG. 7, FIG. 8 and FIG. 9.

FIG. 7: FIG. 7 is an alternative embodiment of the present invention. FIG. 7 shows how the Personal Server (5.10) can join a trusted Personal Server network authorized by the Personal Server Owner. The Personal Server Owner may choose to share some Personal data such as photos, documents with other persons owning a Personal Server. The Personal Server Controller application (5.100) is used to setup the shared data folder or repositories with one or more Personal Servers residing remotely or locally in the same home or office location. Before the sharing can accomplished the Personal Server Owner needs to exchange security credential and or certificates with the authorized Personal Servers. The Personal Server owner can choose to revoke or grant such access using the Personal Server Controller Application. In FIG. 7, Personal Server Owner 1 owning Personal Server (7.710) has setup Personal Server trusted network with Personal Server Owner 2 Personal Server (7.720) and Personal Server Owner 3 (7.730). The Trusted Personal Server network can also be created with multiple personal servers in the same home or office location as it relates with this invention and depicted in FIG. 8 and FIG. 9.

FIG. 8: FIG. 8 is yet another alternative embodiment of the present invention. FIG. 8 shows an alternative embodiment of using the Personal Server (5.10) where Multiple Personal Servers (8.810, 8.880) are connected to the Local Area Network (8. 830) in a Master and Slave mode. In this topology all the Personal Servers shares a single external IP address (8. 890). Multiple hostname and domain names can be associated with the same External IP Address (8.890). Multiple hostname and domain names associated with the Personal Servers are routed through the network router (8.820) to the Master Personal Server (8.810). Configuration in the Master Personal Server (8. 810) route the requests for target applications in the Slave Personal Servers (8.880). The use of multiple Personal Servers in the Local Area Network (8.830) in a home is useful when multiple family members may each have their own Personal Servers. In a small office environment each office member can have their own Personal Server. This alternative embodiment provides limited personal privacy to each of the Personal Server that is configured as Slave Personal Servers (8. 880) because it requires some configuration on the Master Personal Server (8.810) and the requests passing through the Master Personal Server is in the control of the Master Personal Server owner. Therefor it requires a certain element of trust between the Master Personal Server Owner and the Slave Personal Server Owners.

FIG. 9: FIG. 9 is a third alternative embodiment of the present invention. FIG. 9 shows another embodiment of this invention in the use of Personal Server computing appliance where multiple Personal Servers (9.910) are connected to the local area network (9.930). In this embodiment of this invention, multiple external IP address (9.990) is available where each external IP address and its associated hostname and domain name is resolved by the Domain Name Service (9.900); and requests are routed to a specific Personal Server in the Local Area Network (9.930). The network router (9.920) may handle multiple external IP addresses or multiple network routers can be used to connect to the Internet Modem or Internet Modems (9.990). The use of multiple Personal Servers (9.910) in the Local Area Network (9.930) in a home is useful when multiple family members may each have their own Personal Server. In a small office environment each office member can have their own Personal Server. This alternative embodiment provides personal privacy to each of the Personal Server owner as each Personal Server can be configured and administered independently without compromising any privacy concerns.

### INDEX OF ELEMENTS

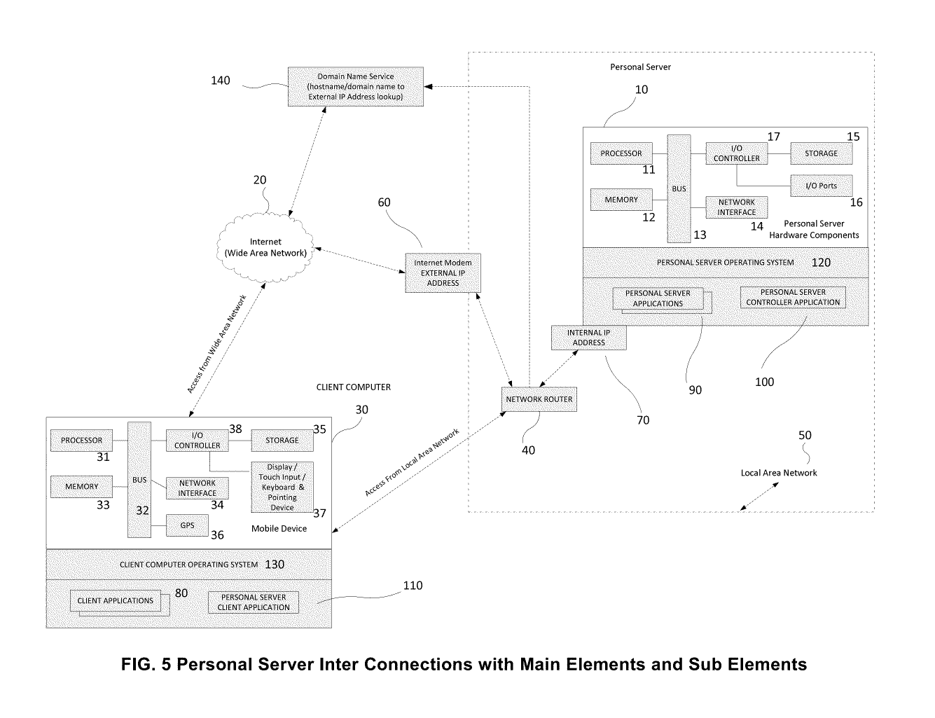

Refer to FIG. 5 for the interconnection of main elements and sub-elements of the system for Personal Server for managing personal data and personal automation tasks.
5.10: Personal Server (5.10)
5.11: Processor
5.12: Memory
5.13: Bus
5.14: Network Interface
5.15: Mass Storage
5.16: I/O Ports
5.17: I/O Controller
5.20: Wide Area Network (internet) (5.20)
5.30: Client Computer (5.30)
5.31: Processor
5.32: Bus
5.33: Memory
5.34: Network Interface
5.35: Storage
5.36: GPS
5.37: Display/Touch Input/Keyboard & Pointing Device
5.38: I/O Controller
5.40: Network Router (5.40)
5.50: Local Area Network (5.50)
5.60: External Ip Address (5.60)
5.70: Internal Ip Address (5.70)
5.80: Client Applications (5.80)
5.90: Personal Server Applications (5.90)
5.100: Personal Server Controller Application (5.100)
5.110: Personal Server Client Application (5.110)
5.120: Personal Server Operating System (5.120)
5.130: Client Computer Operating System (5.130)
5.140: Domain Name Service (5.140)

### DETAILED DESCRIPTION OF EMBODIMENTS

Detailed descriptions of the embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DETAILED DESCRIPTION OF THE INVENTION

### A. Overview

Turning now descriptively to the drawings, in which FIG. 5 shows the main elements and sub elements related with this invention which includes Personal Server (5.10), Personal Server Operating System (5.120), Personal Server Applications (5.90), Personal Server Controller Application (5.100), Local Area Network (5.50), Network Router (5.40), External IP Address (5.60), Internal IP Address (5.70), Wide Area Network (Internet) (5.20), Client Computer (5.30), Client Computer Operating System (5.130), Client Applications (5.80), Personal Server Client Application (5.110) and Domain Name Service (5.140).

### B. Personal Server (5.10)

The Personal Server is the main element of the system described in this invention. The usage of a computing appliance as a personal server especially in a new form factor made possible by advances in computing at low cost, small size and low power consumption including passive cooling technology for noiseless operation enables novel ways of managing and sharing personal data securely and privately that was not possible before.

A Personal Server is a personal computing appliance that is different from a desktop personal computer in a number of ways such as—a Personal Server does not need a computer display monitor and input devices for its normal operation as it is connected to the network and available around the clock. It is designed to run continuously and use very little power. It minimizes or avoids the use of mechanical moving parts for a noiseless operation and improved reliability for example passive cooling technology instead of traditional fan cooling and solid state storage technology instead of traditional hard disk storage. A client computer device can be used to interact and manage the Personal Server computer when required. At other times the Personal Server serves request for personal data and runs scheduled personal automation tasks for the Personal Server owner. A Personal Server is also used as an authorized personal data broker for the Personal Server owner to serve request for personal data that can include documents, personal profile, monitoring data, video, photos and other data that is owned by the Personal server to requesting external applications or users.

A Personal Server housed in the Personal Server owner's home or office location and the Personal Server owner has complete control of the software, data and hardware unlike remote server services owned by third party companies. A Personal Server is connected to the local area network and can be accessed by client computing devices such as a laptop computer, tablet computer, personal desktop computer or a smart phone using standard TCP/IP network protocols such as HTTP, FTP, SSH etc. The Personal Server can also be accessed by a standard internet browser or native user interface that may be proprietary to the client device operating system.

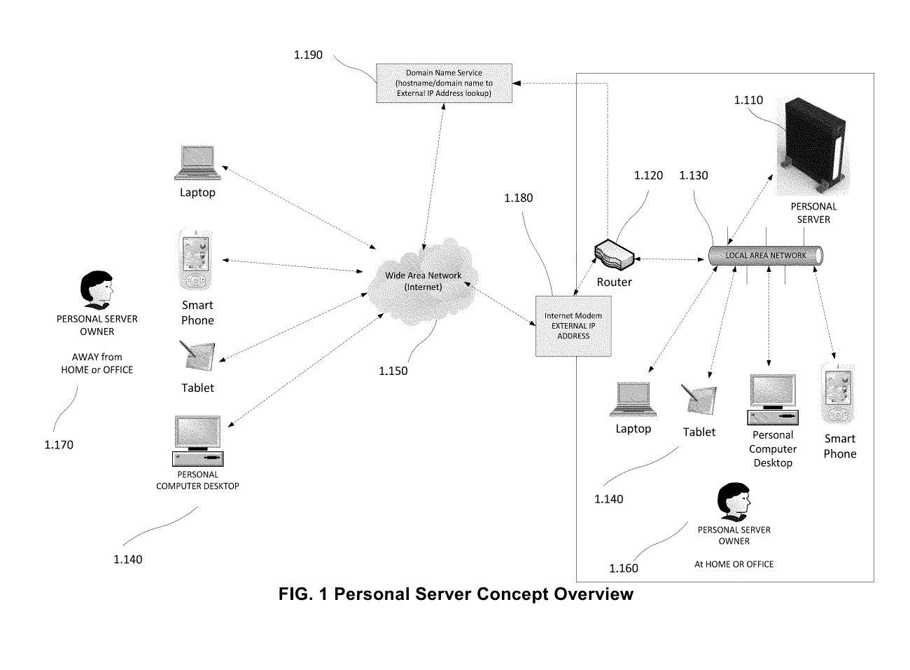

The Personal Server is a key element of the invention as described by the system and as shown in FIG. 1 and FIG. 5. The usage of a computing appliance as a personal server especially in the new form factor that enables small size, noiseless operation and low power consumption enables novel ways of managing and sharing personal data securely and privately that was not possible before.

A Personal Server is a general purpose computer that is designed to run continuously around the clock connected to the home or office network. The Personal Server can be accessed from within the home or office network or from the internet (wide area network) through the network router. The Personal Server can be accessed from any client computer system such mobile device such as a tablet, laptop, tablet or desktop computer using an internet browser or custom native application on the mobile device using standard internet communication protocols.

The personal server may have input output ports to connect a display and input device such as mouse and keyboard, but it is not necessary for normal operation of the personal server to use input output devices. The personal server is built for a silent operation and may include a small quiet fan for cooling or may not include a fan in which case it may use passive cooling technology such as heat sink that dissipate heat rapidly.

Personal Server uses low energy components to reduce the power usage and operating temperature as it is designed for continuous and noiseless operation. Back up functions may be included in the Personal Server to back up Personal Server Owner's personal and system data or additional devices can be easily plugged into the Personal Server for scheduled backup. Personal Server is designed to store the Personal Server owner's data and a small group of additional users such as family and friends that is authorized by the Personal Server owner.

Personal Server Owner may provide access to other family members or office members on the Personal Server so that a single Personal Server may serve multiple users. However the number of such users accessing a Personal Server is small unlike internet servers or business servers that are designed to serve a large number of users. The limited number of users to be served by the Personal Server makes the computing requirement for the Personal Server small which enables the Personal Server to use a smaller form factor without the need for high power and cooling requirements.

Personal Server comprises of a computer processor, memory, mass storage device, network interface and optional input and output ports. It stores the operating system code in the storage device and loads the operating system into memory that controls the hardware and software running on the Personal Server. Personal Server has a set of basic applications and additional custom applications can be installed or downloaded over the network. Personal Server can use asymmetric or symmetric cryptographic software to securely store and transmit user data and all communication between Personal Server and connecting devices.

A Personal Server can have various form factors. In its most common form factor that; it uses low power that does not necessitate the need for a traditional fan to cool the system. It uses passive cooling comprising of metal fins that acts as heat sink to rapidly dissipate heat. The Personal Server can be placed horizontally or vertically using a stand (4.440) to save space.

In another embodiment of the Personal Server apparatus, it can have a small touch screen display (4.420) and additional control unit, to control the display and input from the user for basic configurations without connecting to Personal Server over network.

In another embodiment of the Personal Server apparatus, it can have input and output ports to connect a small portable monitor and keyboard and pointing device such as a computer mouse.

### C. Wide Area Network (Internet) (5.20)

Wide Area Network (Internet) (5.20) is the network of computing devices and network resources connected to the Internet. Wide Area Network is geographically dispersed telecommunications network that can span the globe in a different city, state or country. The home or office network (5.50) is connected to the router that is connected to the Wide Area Network enabling the home or office network to connect to the Wide Area Network or Internet (5.20).

Wide Area Network (Internet) (5.20) is the network of computers connected and directly addressable computers by other computers on the Internet.

The relationship between the Wide Area Network (5.20) and Local Area Network (5.50) where the Personal Server apparatus is located can be technically substituted with any two separate network segment. Each network segment can be isolated and specific application access is granted via the Network Router (5.40) using router rules between the network segments.

### D. Client Computer (5.30)

A Client Computer (5.30) device is a computing device such as a laptop computer, tablet computer, smartphone or a desktop computer that is connected to Local Area Network (5.50) or Wide Area Network (5.20) and can connect to the Personal Server (5.10) computer. Client Computer applications (5.80) use standard network TCP/IP protocols or other proprietary network protocol to communicate to the Personal Server (5.10) to manage the Personal Server or use Personal Server applications (5.90) to manage the Personal Server owner's data and personal automation tasks. The Client Computer (5.30) device should have a display device for graphical user interaction and input devices such as a computer keyboard and pointing device such as a computer mouse or a touch sensitive display for swipe and gesture based interaction on the display device.

A type of Client Computer (5.30) device is a personal desktop computer.

Another embodiment of a Client Computer (5.30) is a mobile device such as a smart phone or a tablet device.

Another embodiment of a Client Computer (5.30) is a laptop computer.

A Client Computer (5.30) device can also be other computing device that is connected to the Wide Area Network (Internet) (5.20) or Local Area Network (5.50) that has a display device and input capability that allows user interaction.

### E. Network Router (5.40)

A network router (5.40) is a device that sits behind the home or office internet service provider's modem (5.60) that provides wide area network service. This device can also be used as a firewall which means it has the ability to block or allow network traffic to computing devices inside a home or office running a local area network. All traffic from the Personal Server and to the Personal Server passes through the network router (5.40)

Network Router (5.40) is a device that is placed in the home or office and connects the local area network to the wide area network. It has additional firewall functions that can be configured to control request from the internet to reach computing devices including the Personal Server and also control the flow of response from the local area network to the wide area network (Internet). The network router also provides wireless or wired network access to mobile devices inside the home or office network. Network router's functionality can also be combined with the Internet Modem device (5.60) function.

Network Router is part of the Local Area Network (5.50). The network router functionality may be combined with the Personal Server (5.10) when multiple network ports are available on the Personal Server. In such scenario the operating system running on Personal Server can provide network router and also Personal Server functions.

### F. Local Area Network (5.50)

Local Area Network (5.50) is the isolated network in home or office where computing devices are connected and interact with each other. Traffic from other local area network or Internet (5.20) needs to go via network router (5.40) to reach a Local Area Network. Local area network uses a private set of IP (Internet Protocol) addresses. The Personal Server is connected to the local area network through its network interface (5.14). Client Computer (5.30) devices of the Personal Server owner also shares the same local area network when interacting with the Personal Server in the home or office environment.

A Local Area Network (5.50) consists of computing devices connected in a home or office environment that is isolated from the Wide Area Network (Internet) (5.20). Requests from the Wide Area Network (Internet) (5.20) pass through a network router (5.40) before it can enter the Local Area Network (5.50).

Local Area Network consists of Network Router (5.40), network inter-connection between the computer devices connected via a network router or a switch device. Connected computer devices are assigned an internal IP Address (5.70) that may be static or dynamic.

A home or office location may have multiple local area networks that may be managed by the same network router.

Multiple Local Area Networks can exist in an environment that may have certain network characteristics based on access and isolation levels between the Local Area Network. Multiple Local Area Networks provides additional isolation and control on the Local Area Network.

### G. External IP Address (5.60)

A typical home or office internet access uses an internet modem that is connected to the network provided by the Internet Service Provider. The internet modem has a unique internet address called external IP address that is assigned by the internet service provider. The external IP address is used by client computers (5.30) to connect. The connection requests are forwarded to the appropriate computing devices by the network router to inside the Local Area Network (5.50), in the case of this invention, the connection request is forwarded to the Personal Server. This external IP address may be dynamic or static based on the service subscribed by the Personal Server owner with the internet service provider. Network Router (5.40) can be configured to pass traffic directed to a specific port on the external IP address to be forwarded to a specific application on the Personal Server. This enables the Personal Server owner to access the Personal Server and Personal Server applications from outside the home or office environment.

A domain name and host name can also be associated with the external IP address. Request using the target hostname and domain name associated with the external IP address and a specific port will resolve to Personal Server application. Multiple domain names and host names can also be assigned to the same external IP address that can resolve to individual Personal Server applications or can be routed to additional Personal Server's in the Local Area Network. This enables accessing different Personal Server Applications (5.90) or Personal Servers with its own host and domain name.

The Wide Area Network (Internet) service provider assigns an external IP address that is used when requests are made from the Wide Area Network (5.60). Requests coming from the Internet (5.60) addressed to the external IP address is received by the Internet modem (5.60) and then forwarded to the Network Router (5.40) that will apply the pre-defined rules to forward the requests on specific ports to the computing devices connected to the Local Area Network. Requests can be routed to Personal Server (5.10) by the Network Router (5.40). From the wide area network perspective requests to the Personal Server (5.10) is associated with the external IP address (5.60). The external IP Address is usually associated with a hostname and domain name which is resolved to the external IP address (5.60) by domain name system (DNS) servers on the internet. The Domain Name Service (5.140) ensures the hostname and domain name associated with the External IP address stays up to date. In certain cases the External IP Address assigned by the Internet Service Provider is dynamic. In such situation, the Network Router (5.40) or the Personal Server (5.10) will update the Domain Name Service with the dynamically assigned External IP Address whenever the External IP Address changes and thus keep the hostname and domain name synchronized with the External IP address.

A home or office network location could have multiple External IP addresses (5.60) that can be connected to multiple Network Routers (5.40) managing multiple Local Area Network (5.50). A Personal Server (5.10) can be connected within each Local Area Network. In another embodiment of this invention multiple Personal Servers can be connected to the same network with one of the Personal Server acting as the master and forwarding Personal Server Application (5.90) requests to other Personal Server on the network. This way a single external IP Address can be used to host multiple Personal Servers.

### H. Internal IP Address (5.70)

An internal IP address (5.70) is the network address assigned to a computing device within the home or office network managed by the network router (5.40). A Personal Server (5.10) is also assigned an internal IP address (5.70). The internal IP address (5.70) can only be directly resolved within the home or office network. The internal IP address can also be associated with a hostname. Any request coming from outside the home or office network uses the external IP address (5.60) or its associated host and domain name. The request is then forwarded by the network router (5.40) to the Internal IP Address (5.70) of the Personal Server (5.10) based on the forwarding rules that apply to the Personal Server (5.10).

A Personal Server (5.10) is assigned a static IP address within the Local Area Network by the Network Router. This IP address is called the Internal IP Address (5.70). Direct connection to internal IP (5.70) address or internal hostname works only with in the home or office network only. The Internet or Wide Area Network (5.20) cannot send request to the Internal IP Address (5.70) directly. All requests from the Internet (5.20) are sent to the external IP Address (5.60) or the associated hostname and domain name. The request from Wide Area Network (Internet) (5.20) is then forwarded to the Personal Server Internal IP Address (5.70) by the Network Router (5.40) based on the configuration on the Network Router (5.40).

Element Internal IP Address (5.70) is part of the Local Area Network (5.50). A local hostname and local domain can be assigned to the Internal IP Address. The Internal IP address (5.70) assigned to the Personal Server (5.10) could be dynamic or static based on the Personal Server configuration. Static internal IP address is preferred as the dynamic internal IP address can change. This would involve re-configuration on the Network Router (5.40) to forward Internet request to the Personal Server (5.10). To avoid the frequent reconfiguration the Personal Server (5.10) is always assigned a static internal IP address. Multiple hostname and domain name can be associated with External IP address (5.60) of the Personal Server. Network Router (5.40) can be configured to forward requests from multiple hostname and domain name to the same Internal IP address (5.70) of the Personal Server (5.10).

### I. Client Applications (5.80)

Client Applications (5.80) run on Client Computer (5.30) devices. Client Applications written specifically for use with a Personal Server (5.10) enables the Personal Server Owner to manage personal data and personal automation tasks. Client Applications (5.80) can be written using the native software libraries that are specific to the Client Computer (5.30) device or they can use the widely available Internet browser or standard internet protocol clients to interact with the Personal Server (5.10). Client Application (5.80) uses secure techniques such as symmetric or asymmetric encryption and pre-installed client certificates to connect securely and privately with the Personal Server (5.10) to ensure the personal data and application data is protected from unauthorized access and manipulations.

Client Applications (5.80) can be written using the Client Computer Operating System (5.130) application programming interface. It may use standard protocols like HTTP (Hyper Text Transfer Protocol), SSH (Secure Shell), SMTP (Simple Mail Transfer Protocol), POP (Post Office Protocol), IMAP (Internet Message Protocol), FTP (File Transfer Protocol), Telnet, DNS (Domain Name Service), DHCP (Dynamic Host Control Protocol), NTP (Network Time Protocol), NetBIOS, SNMP (Simple Network Management Protocol), X11 (X Window Protocol), SSL (Secure Socket Layer) etc.

### J. Personal Server Applications (5.90)

Personal Server Applications (5.90) are software programs that run on the Personal Server and provide a number of services to the owner of the Personal Server. These applications are accessed through a pre-defined port e. g. A web application is accessed by port 80 and port 443, mail server application is accessed by port 25 and so on. Personal Server may come with additional controller software that can help configure the Personal Server Applications. Personal Server Applications can be installed or updated using Personal Server Controller Application (5.100) or Personal Server Operating System (5.120).

Personal Server Applications can be part of the Personal Server Operating System. The Personal Server Application may be a web application that has a server component that runs on the Personal Server which can be accessed using a general purpose internet browser using HTTP or HTTPS protocol or it may offer a native client application that runs on the laptop, tablet, smart phone or desktop client computer that may use standard or proprietary connection protocols.

### K. Personal Server Controller Application (5.100)

Personal Server Controller Application (5.100) is a special application that runs on the Personal Server that facilitates the management of Personal Server, Personal Server security, Personal Server configuration and other Personal Server applications. This application also manages connection from client computers owned by the Personal Server owner and enables client computers to communicate securely with the Personal Server and Personal Server applications.

The Personal Server Controller Application (5.100) is also used to configure the Trusted Personal Server Network or Multiple Personal Server configurations.

The Personal Server Controller application may have a client software component that is configured during initial setup. This client software component may be a client application running on the client computer or it may be software component containing a digital certificate that helps communicate with the Personal Server in a secure manner.

Personal Server Controller application or Personal Server application can use the location data of the Client Computer owned by the Personal Server owner. The location data is provided by the GPS (Global Positional System) sub component in the Client Computer. An example usage is selectively disabling access to certain Personal Server functions from the less secure Wide Area Network when it determines the Personal Server owner is in close proximity of the Personal Server system and therefore can accept request only from trusted local area network. Other applications include enabling certain automation tasks such as turning on home appliance controls based on the presence of the Personal Server owner inside the home or outside the home.

The Personal Server Controller application may be a web application that listens to connection request via a web server listening on standard HTTP ports such as port 80 and port 443.

Another embodiment of the Personal Server Controller Application is a server application using proprietary or custom communication protocol and receiving requests from a custom client application running on client computer.

Another name for Personal Server Controller Application could be Personal Server Configurator Application or Personal Server Configuration Application.

### L. Personal Server Client Application (5.110)

Personal Server Client Application (5.110) is a special application that is specifically developed to connect to the Personal Server (10) and is meant to be used by the Personal Server Owner (1.160, 1.170) from client devices such as a laptop computer, tablet computer, smart phone or a desktop computer. The Personal Server Client Application (5.110) helps configure the Personal Server (5.10) from the Client Computer (5.30). The Personal Server Client Application (5.110) may use standard internet protocols like HTTP (Hyper Text Transfer Protocol) in secure mode to connect to the Personal Server (5.10) for initial configuration and Personal Server Application configuration. The Personal Server Client Application (5.110) may also be implemented as native application written specifically to run on a type of Client Computer (5.30) device using the Client Computer (5.30) platform specific application programming interfaces (API) and services. The Personal Server Client Application (5.110) may also use proprietary network and application protocols.

In another embodiment of the Personal Server Client Application (5.110) that is written to enhance the security and privacy of the Personal Server (5.10) and Personal Server Owner, an initial setup and configuration is required before the Personal Server Client Application (5.110) may access the Personal Server (5.10). During this setup a client certificate and key is installed on the Client Computer (5.30) that is used to communicate to the Personal Server (5.10) and Personal Server Controller Application (5.100) and/or Personal Server Applications (5.90). This ensures the requests coming to the Personal Server are originating from the Personal Server Owner's client computer (5.30) devices only.

### M. Personal Server Operating System (5.120)

Personal Server Operating System (5.120) is the software that controls the Personal Server. The Personal Server Operating System Software could be a customized to suit the Personal Server preferences. Personal Server Operating System controls the Personal Server and manages the Personal Server hardware components—Processor (5.11), Memory (5.12), Bus (5.13), I/O Controller (5.17), Storage (5.15), I/O Ports (5.16), Network Interface (5.14) and Personal Server applications (5.90) and Personal Server Controller Application (5.100). Personal Server Operating System provides security, memory management, power management, network protocol support, storage management functions.

Personal Server may run various kinds of operating system such as Linux, UNIX and others. Personal Server Operating System is customized to consume low power and includes security features customized for Personal Server applications.

To support personal server functions and personal automation tasks, the Personal Server Operating System (5.120) must be capable of running continuously with minimal down time.

### N. Client Computer Operating System (5.130)

Client Computer can run various popular operating systems (5.130) such as Linux, UNIX, Microsoft Windows, Apple iOS, Google Android or custom operating systems. The Client Computer should have TCP/IP network capability to connect to the Personal Server (5.10) computer over the Local Area Network (5.50) or the Wide Area Network (Internet) (5.20). Client Computer Operating System (5.130) should also provide support for display device for user interface and input device or input capabilities for entering keyboard and pointing device capability in the form of a computer mouse or touch sensitive display capability for interaction on the display device.

Client Computer Operating System (5.130) can be custom operating system software that is specifically designed to run on a client computing device.

Client computer devices (5.30) can be portable and mobile or may have a desktop form factor. The Client Computer Operating System should be able to handle the specific type of client computing device.

Client Computer Operating System (5.130) should support standard security capabilities such as HTTPS, asymmetric and symmetric key cryptography, SSL (Secure Socket Library) to communicate to the Personal Server securely and privately.

### O. Domain Name Service (5.140)

The Wide Area Network (Internet) (5.20) connection to a home or office location is assigned an external IP address (5.60). Accessing the home or office network away from the home or office requires the use of this external IP address (5.60). To make the access easier to humans a hostname and domain name can be associated with the external IP address.

A Domain Name Service (5.140) facilitates the use of a host name and domain name when accessing the Personal Server (5.10). The hostname and domain name is registered with the Domain Name Service along with the associated external IP address (5.60) that is used to connect to the Personal Server (5.10). This association is done by registering the hostname and domain name to a Domain Name Service (5.20). The Domain Name Service (5.140) broadcasts this association to all the Domain Name System Servers (DNS Servers) in the Wide Area Network (Internet) (5.20) so that all client computers connected to the Wide Area Network (Internet) is able to connect to the Personal Server using the hostname and domain name automatically. The domain name service is a third party service the Personal Server owner subscribes to be able to access the Personal Server (5.10) without remembering the External IP Address (5.60). The Domain Name Service (5.140) is also useful when the External IP Address (5.60) is assigned by the Internet Service Provider as a dynamic address. All modern Network Routers (5.40) have the capability to detect a change in the External IP Address (5.60) and communicate the new External IP Address (5.60) to the Domain Name Service (5.20) automatically. This greatly facilitates the use of the Personal Server by the Personal Server owner when accessing the Personal Server (5.10) away from home or office location. While the use of host name and domain name is not required for all personal server application the use of a host name and domain name enables ease of using the Personal Server Applications (5.90) from the Client Computer (5.30) devices.

Other forms of standard lookup may be employed, where the Client Computer (5.30) can bypass the Domain Name System Servers by associating the name to external IP address mapping in a local file in the Client Computer (5.30). However some Personal Server Applications (5.90) may require the use of a hostname or domain name to function correctly. Future technology standards may provide similar function of mapping a hostname and domain name to the external IP address (5.60) of the target Personal Server.

### P. Connections of Main Elements and Sub-Elements of Invention

FIG. 5 shows the interconnections of the Main Elements and Sub-Elements related with this invention.

The primary element of this invention is the Personal Server computing appliance (5.10). The Personal Server (5.10) is composed of Processor (5.11), Memory (5.12), Bus (5.13), I/O Controller (5.17), I/O Ports (5.16), Storage (5.15), and Network Interface (5.14).

The Personal Server (5.10) runs Personal Server Operating System (5.120) which is the software component that controls the Personal Server (5.10) hardware and Personal Server Applications (5.90) and Personal Server Controller Application (5.100). It also provides necessary services to securely connect with Personal Server Owner's Client Computer (5.30) devices and to protect Personal Server owner's data and manage the automation tasks.

The Personal Server (5.10) is connected to the Local Area Network (5.50) that is controlled by a Network Router device (5.40). The Personal Server (5.10) can be addressed via an external IP address or associated hostname and domain (5.60) when requests originate from the wide area network (internet) (5.20) or using an internal IP address or internal hostname (5.70) within in the Local Area Network (5.50).

Personal Server (5.10) runs Personal Server Applications (5.90) and also includes a special application Personal Server Controller Application (5.100). Personal Server Applications (5.90) and Personal Server Controller Application (5.100) is accessed using standard internet protocols such as HTTP, HTTPS, FTP, SSH, X11 etc. Personal Server application employ security policies to ensure the Personal Server Owner's data is secured and protected from unauthorized access.

The Client Computer (5.30) is used by the Personal Server owner to access the Personal Server (5.10) to manage the personal data, control and configure Personal Server (5.10), setup automation tasks for home and office.

The Client Computer (5.30) consists of a Processor (5.31), Memory (5.33), I/O Controller (5.38), storage (5.35), Display/Touch Input or Keyboard and Pointing Device 948 (5.37), Network Interface (5.34) and Global Positioning System component (GPS) (5.36).

The Client Computer (5.30) connects to the Personal Server (5.10) from the Wide Area Network (internet) (5.20) or from the Local Area Network (5.50).

The Client Computer (5.30) runs Client Computer Operating System (5.130) that controls the hardware and software components of the Client Computer (5.30). The software components include Client Computer Applications (5.80) and Personal Server Client Application (5.110).

### Q. Alternative Embodiments of Invention

This invention describes the use of a Personal Server (5.10) computing appliance and how it is connected with a Client Computer (5.30) that is used by the Personal Server Owner to manage Personal Data and Home or Office Automation Tasks.

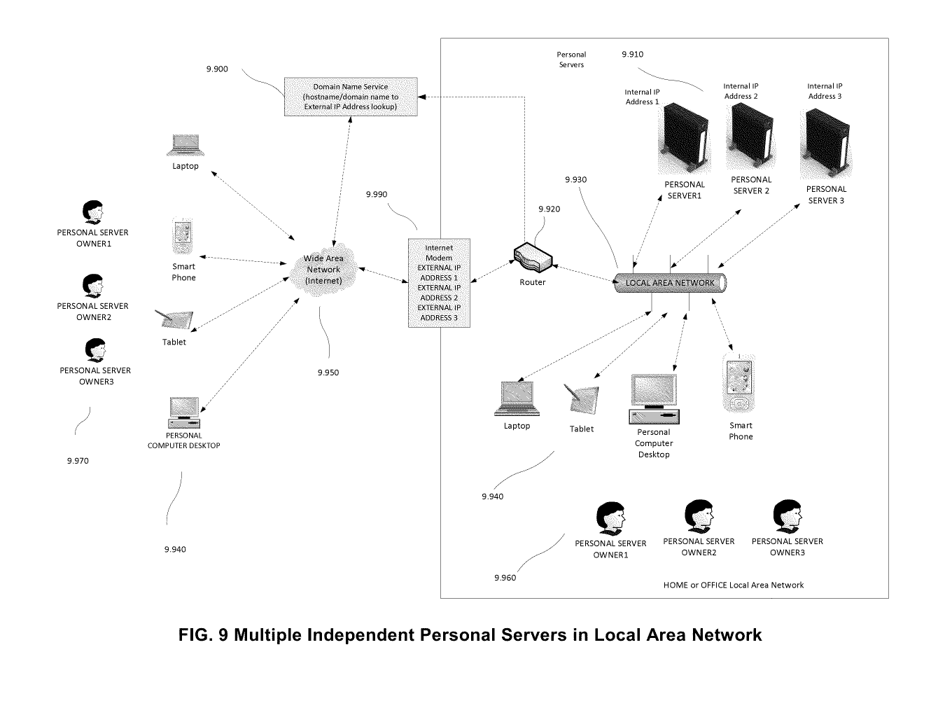

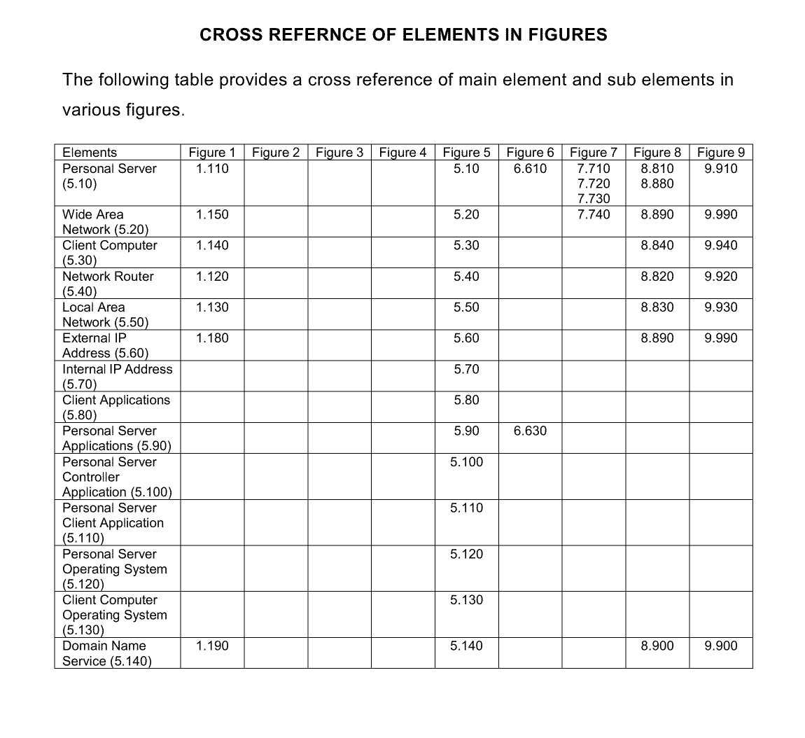

In another embodiment of this invention, multiple Personal Servers may exist in the Local Area Network that can each have a unique External IP Address (5.60) and a unique hostname and domain name assigned to it. This embodiment is shown in FIG. 9. Each Personal Server (9.910) is associated with a unique external IP address which in turn could be associated with a hostname and domain name. Each Personal Servers (9.910) is also assigned independent Internal IP address (5.70). Requests are routed by the network router (9.920) to the target Personal Server (9.910) based on the external IP address, external hostname and domain name or internal IP address (5.70) and/or internal hostname and domain name. Using the Multiple Personal Severs in this embodiment provides complete control of the Personal Server data and privacy for the Personal Server Owner.

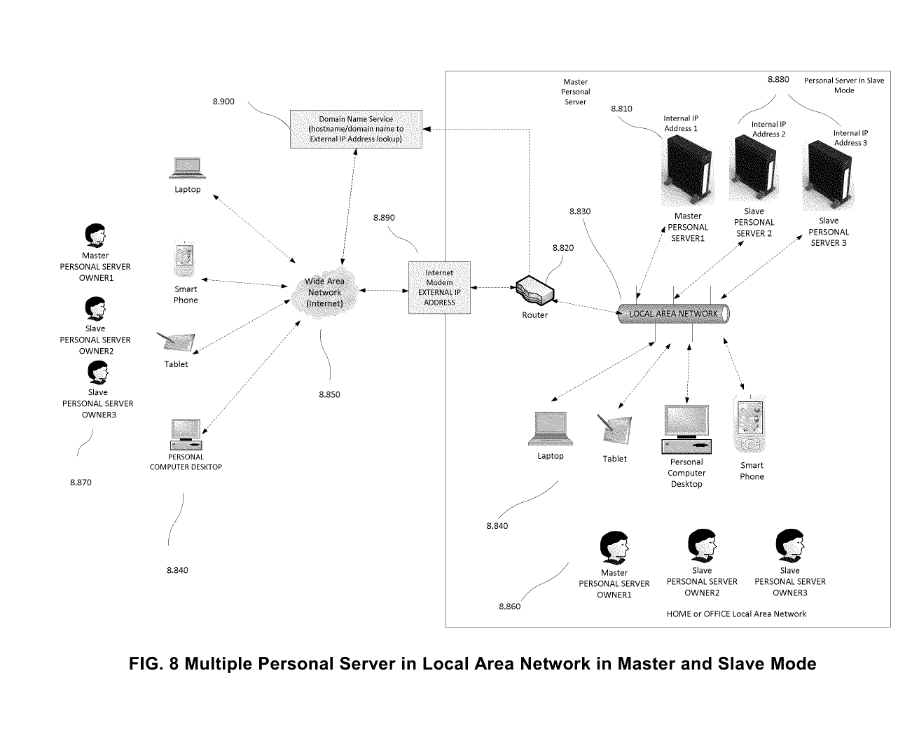

In another embodiment of this invention as shown in FIG. 8, multiple Personal Servers may share the same external IP address but may be assigned a separate hostname and domain name. The master Personal Server (8. 810) would then forward the requests destined to other slave Personal Servers (8. 880) in the Local Area Network (8.830). Routing rules can be configured using the Master Personal Server Controller Application (100) on the master Personal Server (8.810) accessed by Personal Server Client Application (5.110) to route the request for Slave Personal Servers (8.880) within the same Local Area Network (8.830). Using the Personal Servers in this topology enables sharing a single external IP address and domain name between multiple Personal Servers. Each Personal Server will be assigned a unique internal IP address and internal hostname. The master Personal Server (8.810) is configured to route request to specific Slave Personal Server applications based on the target external hostname and domain name. Compared to the embodiment depicted in FIG. 9, this embodiment of the use of Personal Servers requires trusted relationship between the Master Personal Server owner and the Slave Personal Server owners.

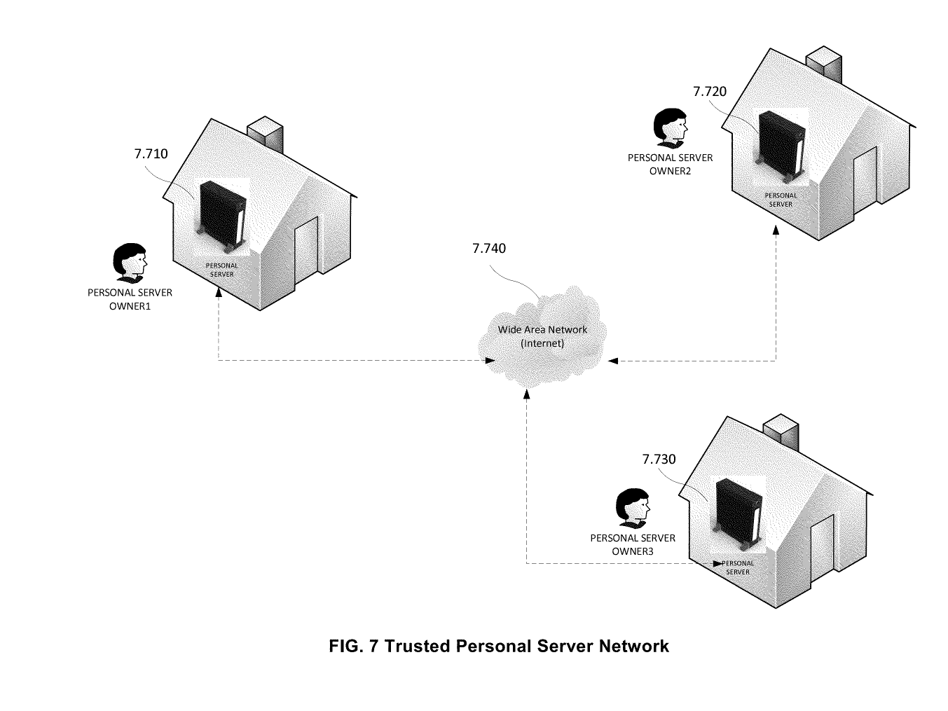

In another embodiment of this invention as shown in FIG. 7, multiple Personal Servers (7. 710, 7.720, 7.730) can form a network of Personal Servers over the Wide Area Network (7.740). This trusted network of Personal Servers can share pre-defined data repositories. This type of trusted Personal Server Network is useful in sharing personal data between family members or between office members in multiple small office environments where each of the Personal Servers are geographically dispersed.

### R. Operation of Preferred Embodiment

This invention introduces the system, method and apparatus for a Personal Server (1.110) for managing, storing, sharing of Personal Server Owner's data and managing the personal automation tasks at home and office premises. A Personal Server (1.110) is located in a home or an office environment and connected to the Local Area Network (1.130). When connecting to the Local Area Network (1.130) it is also assigned an internal IP Address (5.70) and an internal hostname and local domain.

While the concept of a computer server is not new, but computer servers until today are typically used in a business environment where the computer server serves hundreds and even millions of users. The Personal Server concept discussed in this invention is for personal usage. The requirements for a Personal Server are vastly different from a general purpose computer server. This invention describes the utility of computing appliance for a Personal Server. Along with the practical form factor and the software applications this invention talks about the system, method and apparatus for a Personal Server to manage personal data and personal home or office automation tasks.

### [01] Personal Server.

The main element of this invention is the Personal Server (5.10) and it is a novel concept in personal computing. It is a personal computing appliance that is different from a personal computer or a desktop personal computer in a number of ways such as—a Personal Server does not need a computer display monitor and input devices for its normal operation. It is also designed to run continuously and hence designed to use very low power.

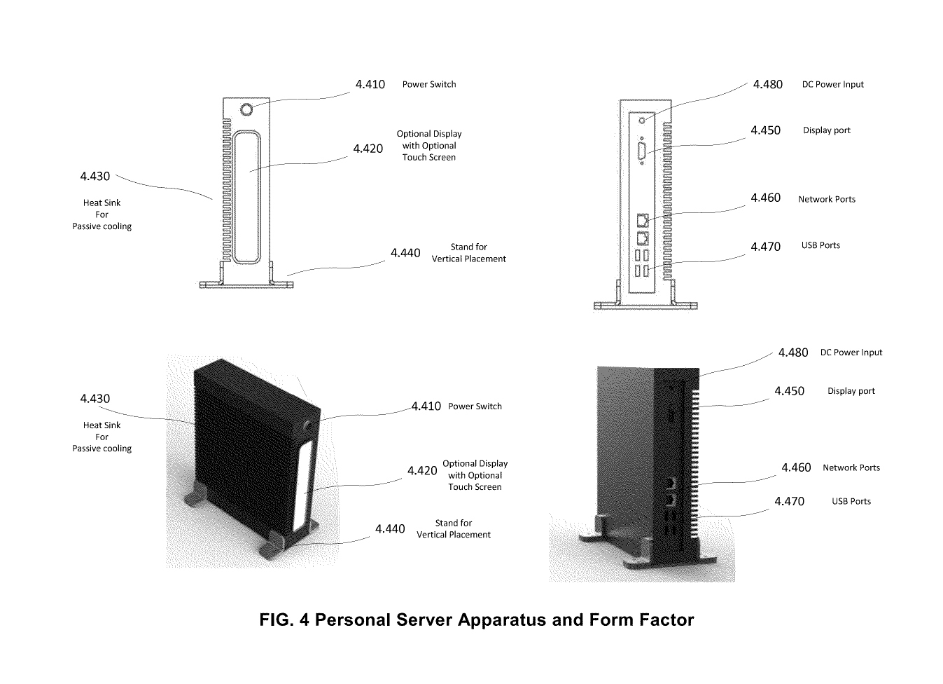

FIG. 4 shows a typical Personal Server form factor that is suitable for this invention. The Personal Server form factor (see FIG. 4) represents a small size that can be placed on the desktop and equivalent to the size of an average reading book. It can be placed horizontally or vertically occupying very small space. It avoids the use of moving parts by using passive cooling technology (4.430) that does not necessitate it to have a fan typically found in more compute intensive desktop computers and larger computer servers. It may use solid state storage technology to reduce mechanical parts for longer life and reduced noise operation. The only wired connection it requires for its operation is a DC power adapter that provides DC power to the apparatus and a network cable. The DC Power adapter is input to power input port (4.480) and network cable is attached to network port (4.460). It can optionally work on wireless network although a wired network will provide better security and faster access to personal server data and applications. All other interfaces are optional for its normal operation. Additional network ports on Personal Server can provide additional function for a network router and firewall. The Personal Server may have ports for a display device (4.450), keyboard and pointing device (4.460, 4.470) such as a mouse. The input and output devices on the server is used rarely only for trouble shooting. All user interaction with the Personal Server is done using a Client Computer using standard or proprietary network protocols. Other form factors are possible, however to ensure the usefulness as a Personal Server it should conform to low power usage, preferably noiseless operation and small form factor and continuous operation. The key software function of the Personal Server includes but not limited to are encrypted backup and restore operation, personal mail server, secured encrypted personal repository of documents, authorized personal data sharing, secure exchange of secured content directly from the Personal Server without a third party server or system, scheduled automation tasks and notifications to the Personal Server owner.

### [02] Personal Server Location

A Personal Server is housed in the Personal Server owner's home or office location and the Personal Server owner has complete control of the software, data and hardware unlike a remote third party server which is owned by third party companies and adheres to their data policies. A Personal Server is connected to the local area network (1.130) and can be accessed by client computing devices (1.140) such as a laptop computer, tablet computer, personal desktop computer or a smart phone using standard TCP/IP network protocols such as HTTP, FTP, SSH etc. The Personal Server (1.110) can also be accessed by a standard internet browser or native user interface that may be proprietary to the client device operating system.

The home or office Local Area Network (1.130) is also connected to a network router (1.120) which can connect to an Internet Service Provider modem enabling the Wide Area Network (Internet) (1.150) to access the Personal Server (1.110). The Internet Service Provider modem that connects the Local Area Network to the Wide Area Network may be assigned one or more external IP address. A hostname and domain name may also be associated with the external IP address (1.180). The external IP address (1.180) could be dynamic or static. The network router (1.120) has the capability to update the Domain Name Service (1.190) with a new dynamic external IP address automatically enabling a dynamic IP address to be addressable by a well-known hostname and domain name. In this setup the Personal Server (1.110) can be accessed by client computer devices (1.140) via the Wide Area Network (Internet) (1.150) from outside the home or office location.

### [03] Personal Server Components.

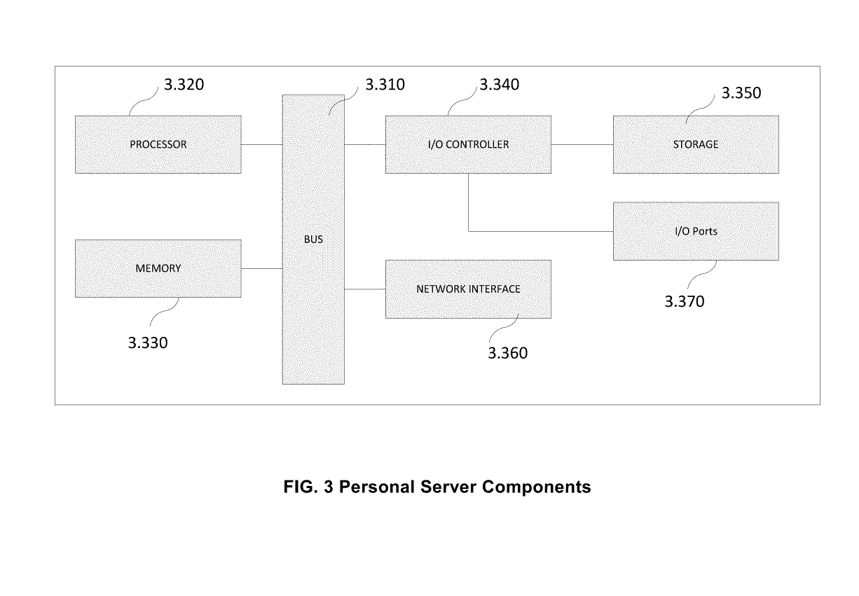

FIG. 3 shows the internal component of a Personal Server. It includes a processor (3.320), memory (3.330), bus (3.310), I/O Controller (3.340), storage (3.350), I/O Ports (3.370) and Network Interface (3.360). The network interface may have capabilities to support a wireless network.

Additional capabilities can be easily incorporated into the Personal Server via the I/O port interface such as USB (universal Serial Bus) port. For example it may include an additional wireless network capability using a USB interface. The I/O ports may also include a display port.

### [04] Client Computer

The Client Computer device (1.140) such as a laptop, smart phone, tablet computer or personal desktop computer is used to interact with the Personal Server (1.110). In a home or office environment, the Client Computers (1.140) is connected to the same Local Area Network (1.130) as the Personal Server (1.110). With the popularity of mobile devices such as smart phone, tablet and laptop type of Client Computer, the users want to access and share their personal data from any location. Consolidating and securing the personal data on the Personal Server (1.140) that is placed securely in the Personal Server owner's home or office location ensures the data is stored privately and securely with complete control by the Personal Server Owner (1.160). The Client Computer (1.140) can connect and interact with the Personal Server (1.110) even when outside the home or office location via the Wide Area Network or Internet (1.150). Keeping the personal data safely inside the Personal Server Owner's home and having access to the Personal Data from home or office location or outside the home or office location securely and privately is the main benefits of the Personal Server (1.110). Personal Server data is only available to the Personal Server Owner and users that have been specifically authorized by the Personal Server Owner.

### [05] Client Computer Components

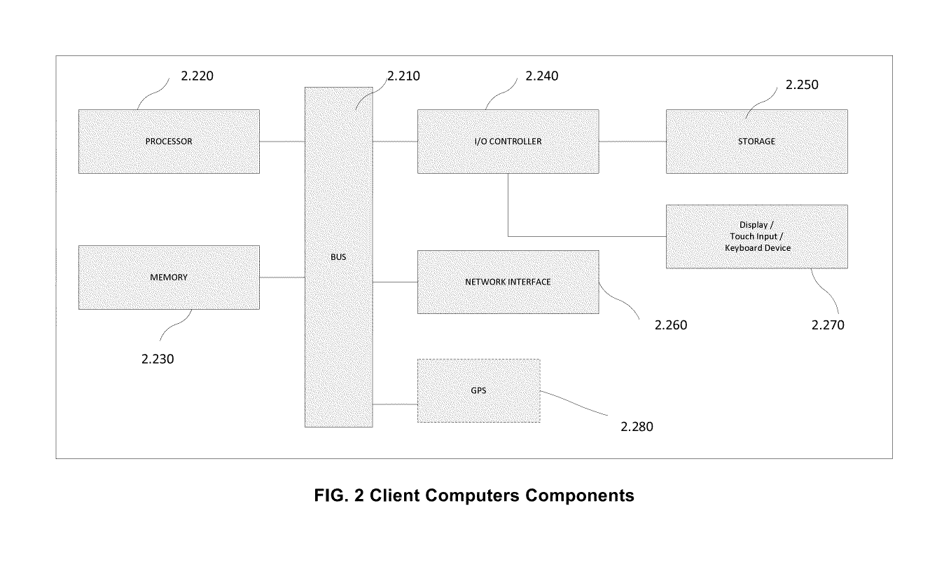

The minimum set of Client Computer (5.30) components to use the Personal Server (5.10) effectively is shown in FIG. 2. The client computer has a processor (2.220), Bus (2.210) that interconnects the various components of the client computer, memory (2.230), Input/Output Controller (2.240), Network Interface (2.260), mass Storage (2.250), Display device, input devices (2.270) such as keyboard, pointing mouse or a touch sensitive display for accepting user input.

The client computer may optionally have a global positioning system (GPS) (2.280) that can determine the geo location of the client computer. The geo location of the Client Computer used by the Personal Server owner can be used to determine the location of the Client Computer and hence the location of the Personal Server owner. The geo location information can be sent to the Personal Server controller application and Personal Server application to provide location based services for example determine if certain applications can be disabled from wide area network and enable only from the trusted and secured local area network based on the current location of the Personal Server owner. The selective disabling of the wide area network can improve the security of the Personal Server. Other application can involve scheduling and controlling tasks based on the location of the Personal Server owner for example turning on home appliances, controlling the heating and cooling of the residence of the personal server owner. It is to be understood the usage of personal location information is not restricted to the examples and other applications using personal server system are possible based on the location data polled from the client computer device.

The Client Computer may have additional components either built-in or connected outside via input/output port such as a Universal Serial Bus (USB) port.

### [06] Personal Server Controller Application

Personal Server Controller Application (5.100) is a software application that runs on the Personal Server (5.10). This application provides functions to manage the Personal Server (5.10) and Personal Server applications (5.90) by the Personal Server owner (1.160). Personal Server Controller Application (5.100) is responsible for configuring and setting up the key configuration by the Personal Server owner. It provides functions to create encrypted backups configure Personal Server as a mail server, configure Personal Server for personal cloud applications and other personal applications that can be downloaded and installed to complement the key functions provided by the main controller application. It can act like a portal application which the Personal Server owner uses to track the Personal Server configuration, Personal Server Applications configuration and Personal Server data.

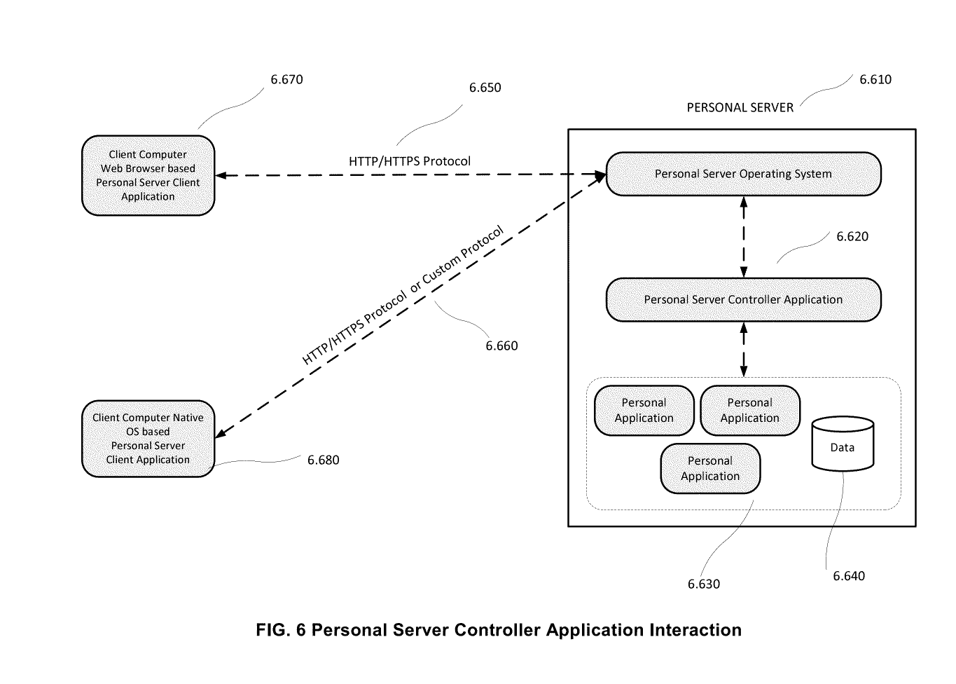

FIG. 6 shows the interaction between the Personal Server Controller Application and other software components within the Personal Server (6.610) and Client Computer (5.30). The Personal Server Controller Application (6.620) can be accessed using any internet web browser running on the client computer devices (6.670) or using a native client computer application (6.680) that uses native libraries of the Client Computer (5.30) device.

Personal Server Controller Application (5.100) is designed to be secured and accessed by the Personal Server Owner only. Secure Socket Layer (SSL) technology is used to ensure confidentiality of all communication between the Client Computer (5.30) and Personal Server (5.10). Personal Server Controller Application (5.100) is also designed to authenticate the Personal Server Owner using an ID and Password. Optionally it may include authentication using a Client Certificate and key. The Client Certificate and key is installed on the Client Computer (5.30) by downloading it from the Personal Server (5.10) during the initial configuration and setup of the Personal Server Controller Application (5.100). Once the Client Certificate and key is downloaded onto the Client Computer (30) it is sent to the Personal Server Controller Application (5.100) during the initial session setup when communicating with the Personal Server.

Once the Personal Server Owner logs into the Personal Server Controller Application, the Personal Server Owner can get the current status of the Personal Server Configuration, Personal Server Application Configuration and access to Personal Data. Personal Server Controller Application also enables the Personal Server Owner to create and schedule automated tasks. Some example of scheduled automated tasks is to send reminder electronic mails to the Personal Server Owner or having the Personal Server control home equipment such as a Sprinkler System or the Air Conditioner, synchronize selected Personal Data Folder to a backup device or sharing a pre-selected Personal Data Folder with trusted Personal Servers in a trusted Personal Server network etc.

### [07] Trusted Personal Server Network

The Trusted Personal Server Network concept is show in FIG. 7. A Trusted Personal Network is the network of Personal Servers (7.710, 7.210, 7.310) owned by different persons either located in the same network or geographically dispersed in different location as shown in FIG. 7. The Personal Servers are connected via the Wide Area Network (7.310). Each individual Personal Server owner has agreed to exchange security credential between the Personal Servers so that they can communicate and share pre-defined data folders or data repository and exchange messages via Personal Server Applications.

An example usage application for Trusted Personal Server Network is where a Personal Server Owner may want to share their photos with their family member who also owns a Personal Server. In this scenario the Personal Server Owner will exchange security credentials between the family member and enable their Personal Server Owner to trust each of their Personal Servers. Once the initial setup and configuration is done the Personal Servers can communicate and exchange data automatically. The Trusted Personal Server Network enables sharing of data and notifications between the Personal Servers in the network to be accomplished automatically. The data exchange between Personal Servers can be retried in case of network unavailability or errors without the intervention of the Personal Server Owners.

### [08] Multiple Personal Servers in Local Area Network—Master and Slave Mode.

FIG. 8 shows an alternative embodiment of using the Personal Server where Multiple Personal Servers are connected to the Local Area Network (8.830) in a Master and Slave mode. In this embodiment all the Personal Servers shares a single external IP address (8.890). Multiple hostname and domain names associated with the Personal Servers are routed through the network router (8.820) to the Master Personal Server (8.810). Configuration in the Master Personal Server (8.810) route the requests for target applications in the Slave Personal Servers (8.880). An example configuration that maps the externally addressable hostname and domain name to the Personal Servers is provided below:

For the sake of an example assume:
ps1.mydomain.com is the externally addressable name for Master Personal Server 1.
ps2.mydomain2.com is the externally addressable name for Slave Personal Server 2.
ps3.mydomain3.com is the externally addressable name for Slave Personal Server 3.

Assume for this example sake from the Wide Area Network (8.850) the all the above host name and domain names is set to resolve to external IP Address—78.11.12.13 in the domain name server (DNS), that is to say:

ps1.mydomain.com will resolve to 78.11.12.13
ps2.mydomain2.com will resolve to 78.11.12.13
ps3.mydomain3.com will resolve to 78.11.12.13

The network router (8.820) is setup to route the entire request with the target hostname and domain to the Master Personal Server 1 (8.810).

The Master Personal Server 1 will receive requests for ps1.mydomain.com for itself.
The Master Personal Server1 (8.810) will receive and then route the request for ps2.mydomain2.com to Slave Personal Server 2 (8.880).
The Master Personal Server1 (8.810) will receive and then route the request for ps3.mydomain3.com to Salve Personal Server 3 (8.880).

The use of multiple Personal Servers in the Local Area Network in a home is useful when multiple family members may each have their own Personal Server. In a small office environment each office member can have their own Personal Server. This alternative embodiment provides limited personal privacy to each of the Personal Server as the Slave Personal Server requires some configuration on the Master Personal Server and requires a certain element of trust between the Master Personal Server owner and the Slave Personal Server Owner.

### [09] Multiple Personal Servers in Local Area Network—Independent Mode

FIG. 9 shows an another embodiment of this invention in the use of Personal Server computing appliance where multiple Personal Servers (9.910) are connected to the local area network (9.930). In this embodiment multiple external IP address (9.990) is available where each external IP address (9.990) and its associated hostname and domain name is routed to a specific Personal Server in the Local Area Network (9.930).

The use of multiple Personal Servers (9.910) in the Local Area Network (9.930) in a home is useful when multiple family members may each have their own Personal Server. In a small office environment each office member can have their own Personal Server. This alternative embodiment provides personal privacy to each of the Personal Server as each Personal Server can be configured and administered independently without compromising any privacy concerns.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for managing personal data and personal automation tasks; comprising of one or more client computer, wide area network, one or more personal server computer, network router, local area network, external IP address, internal IP address, client applications, personal server applications, personal server controller application, personal server client applications, personal server operating system, client computer operating system and domain name service system components.

2. A system as claimed in 1, wherein the system component personal server that contains processor, memory, one or more input/output (I/O) controller, one or more mass storage device for storing program code instructions for the operating system, applications, system and personal data; one or more networking interface, a system bus that connects the various components and facilitates data transfer and control; one or more software application to manage and configure personal server for backup, restore, secure data exchange, mail server, web server, data sharing, authorized peer server sharing, authentication and authorization, creation of scheduled tasks, monitor and respond to external device events and notifications.

3. A system as claimed in 1, wherein the system component personal server connects to the local area network and the wide area network also called internet through its network interface or wireless network interface.

4. A system as claimed in 1, wherein the system component personal server connects to external mass storage device when creating encrypted backups and restoring from backups.

5. A system as claimed in 1, wherein the system component personal server comprises of a secured web server, one or more databases, secured mail server, secured content serving applications, scheduler application, monitoring agents that use standard internet protocols specifically adapted and tuned to serve the personal server owner and trusted users authorized by the personal server owner.

6. An apparatus for system component personal server of system claimed in 1, with space saving form factor that can run around the clock.

7. An apparatus as claimed in 6, with passive cooling to dissipate heat and low noise components for around the clock noiseless operation.

8. An apparatus as claimed in 6, with optional display and control unit that shows the status of the personal server and console messages for the personal server.

9. An apparatus as claimed in 6, with optional display unit with touch sensitive feature for input selections to interact with the personal server during system startup and providing system level command input.

10. An apparatus as claimed in 6, with input and output connection interface inlets and outlets for inter connections with one or more network devices, input and output devices including but not limited to external storage devices.

11. An apparatus as claimed in 6, that can be placed horizontally or vertically with an adjustable supporting stands.

12. An apparatus as claimed in 6, comprising of system component personal server as claimed in 2; with an integrated system component network router of system as claimed in 1.

13. A method for configuring the personal server, personal server applications and manage personal server data access; encapsulated in the element personal server controller application that is accessible from client computer in the system as claimed 1.

14. A method as claimed in 13, comprising of method for configuration of network router configuration elements when apparatus as claimed in 12 includes integrated system component network router.

15. A method to configure and provide access to personal data from home network and wide area network from client computer in the system as claimed in 1.

16. A method as claimed in 13, to utilize the global positioning system of the client computer as claimed in 1, client computer is also owned by the personal server owner; to determine the location of personal server owner in relation to the location of personal server system as claimed in 1; which is placed at the premises of the personal server owner, and utilizing the location data from the client computer to control certain aspects the personal server controller application and personal server applications.

17. A method for adding and configuring more than one personal server in a system as claimed in 1, in independent mode that isolates each personal server data and therefore can be owned by individual owners at the same premises for complete privacy and control of their personal data.

18. A method for adding and configuring more than one personal server in a system as claimed in 1, in master and slave mode with limited privacy and control for personal servers configured in slave mode and full privacy and control for the personal server configured in master mode.

19. A system comprising of multiple systems as claimed in 1, to create a trusted peer network between system component personal server for automatic sharing of pre-defined and pre-authorized personal data repository between personal servers within each of the system as claimed in 1.
